(19) United States
(12) Patent Application Publication
(10) Pub. No.: US 2016/0283943 A1
(43) Pub. Date: Sep. 29, 2016

(54) SYSTEM AND METHODS THEREOF FOR MONITORING FINANCIAL TRANSACTIONS FROM A CREDIT CLEARING DEVICE

(71) Applicants: Amos HACMUN, Tel Aviv (IL); Dor HESKIA, Tel Aviv (IL)

(72) Inventors: Amos HACMUN, Tel Aviv (IL); Dor HESKIA, Tel Aviv (IL)

(21) Appl. No.: 15/172,198

(22) Filed: Jun. 3, 2016

Related U.S. Application Data
(63) Continuation of application No. PCT/IL2014/051047, filed on Dec. 2, 2014.
(60) Provisional application No. 61/944,081, filed on Feb. 25, 2014.
(60) Provisional application No. 61/912,101, filed on Dec. 5, 2013.

(51) Int. Cl. G06Q 20/40; G06Q 20/02; G06Q 20/32; G06Q 20/10

(52) U.S. Cl. CPC G06Q 20/4016; G06Q 20/1085; G06Q 20/02; G06Q 20/325; G06Q 20/405; G06Q 20/409

(57) ABSTRACT

A method and system for approval of an electronic payment by a credit clearing device (CCD) are provided. The method includes receiving a first notification respective of a payment card used to attempt a financial transaction from the CCD, the first notification containing information respective of the payment card and the attempted financial transaction; determining whether the financial transaction requires an external authorization based on at least an analysis of at least a portion of the information contained in the first notification; upon determination that an external authorization is required, identifying at least one pre-selected user device to authorize the attempted financial transaction; sending a second notification to the at least one user device; and sending a third notification to the CCD respective of a response from the at least one user device, wherein the response is any one of: an approval of the attempted financial transaction, and a denial of the attempted financial transaction.

### CROSS-REFERENCE TO RELATED APPLICATIONS

This application is a continuation of International Application No. PCT/IL2014/051047 filed on Dec. 2, 2014 which claims the benefit of U.S. Provisional Patent Application No. 61/944,081, entitled “A System and Methods Thereof for Monitoring Financial Transactions From a Credit Clearing Device”, which was filed on Dec. 25, 2013 and of U.S. Provisional Patent Application No. 61/912,101, entitled “A System and Methods Thereof for Monitoring Cash Withdrawal From an Automated Teller Machine”, which was filed on Dec. 5, 2013. The above referenced applications are incorporated herein by reference for all that they contain.

### TECHNICAL FIELD

The invention generally relates to the authorization of cash withdrawals and, more specifically, to authorization requests for financial transactions received from credit clearing devices (CCDs).

### BACKGROUND

Credit and debit card theft, abuse, and fraud have become increasingly serious problems as cards for engaging in financial transactions have massively increased in number. Attempts to detect and prevent unauthorized use of such cards typically results in the card being automatically blocked. Such prevention mechanisms are typically activated, for example, in cash withdrawal attempts, upon identification of a received wrong password or a request to withdraw cash in amounts that are above a certain predetermined threshold. Therefore, in cases where the received password is correct and the cash amount does not exceed the predetermined threshold, such mechanisms will not prevent a theft, abuse, or fraud attempt initiated by a card holder with the password.

Typically, existing solutions do not allow reasonable protection from theft, abuse, or fraud in situations where, for example, the holder of the card is a child or an employee who is supposed to use the card and has the password. Yet, in daily life, parents may need to provide their children with a credit or debit card just as an employer may need to provide an employee with a credit or debit card to withdraw cash or to make payments. In such cases, an additional layer of security preventing someone who obtains the card and/or the password from the holder of the card would be desirable. As a non-limiting example of a situation in which an additional layer of security beyond a password and card requirement would be desirable, a thief steals a card from a child whose parents provided him the card and obtains the password from the child. In such a situation, additional verification that the child is using the card may be desirable to prevent such a thief from using the card. As a non-limiting example of a situation in which an additional layer of security beyond a password and card requirement would be desirable, an employee may use the card for personal shopping. In such a situation, additional verification that the employee is using the card only for its intent.

It would be therefore advantageous to provide a solution for allowing real-time independent approvals of a cash withdrawal or a payment attempt subsequent to an attempt to perform such financial transactions.

### SUMMARY

Certain exemplary disclosed herein include a method and system for approval of an electronic payment by a credit clearing device (CCD). The method comprises receiving a first notification respective of a payment card used to attempt a financial transaction from the CCD, the first notification containing information respective of the payment card and the attempted financial transaction; determining whether the financial transaction requires an external authorization based on at least an analysis of at least a portion of the information contained in the first notification; upon determination that an external authorization is required, identifying at least one pre-selected user device to authorize the attempted financial transaction; sending a second notification to the at least one user device; and sending a third notification to the CCD respective of a response from the at least one user device, wherein the response is any one of: an approval of the attempted financial transaction, and a denial of the attempted financial transaction.

The system comprises a processing system; and a memory, the memory containing instructions that, when executed by the processing unit, configure the system to: receive a first notification respective of a payment card used to attempt a financial transaction from the CCD, the first notification containing information respective of the payment card and the attempted financial transaction; determine whether the financial transaction requires an external authorization based on at least an analysis of at least a portion of the information contained in the first notification; upon determination that an external authorization is required, identify at least one pre-selected user device to authorize the attempted financial transaction; send a second notification to the at least one user device; and send a third notification to the CCD respective of a response from the at least one user device, wherein the response is any one of: an approval of the attempted financial transaction, and a denial of the attempted financial transaction.

### BRIEF DESCRIPTION OF THE DRAWINGS

The subject matter of the disclosed embodiments is particularly pointed out and distinctly claimed in the claims at the conclusion of the specification. The foregoing and other objects, features and advantages of the disclosed embodiments will be apparent from the following detailed description taken in conjunction with the accompanying drawings.

FIG. 1 is a schematic diagram of a system for monitoring financial transactions from a credit clearing device in accordance with one embodiment; and

FIG. 2 is a flowchart illustrating a method for approving financial transaction from a credit clearing device (CCD) according to an embodiment.

### DETAILED DESCRIPTION

The embodiments disclosed herein are only examples of the many possible advantageous uses and implementations of the innovative teachings presented herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

According to various disclosed embodiments, a request for a financial transaction such as a cash withdrawal or a payment attempt from a credit clearing device (CCD) is received. It is determined whether the financial transaction requires an external approval from an entity other than the service provider. Upon determination that an approval is required, at least a user device that is configured to authorize the financial transaction is identified. A notification regarding the attempt is sent to the at least one user device. Upon receiving an approval for the attempt, typically within a predetermined time-limit, an authorization notification is sent to the CCD and the financial transaction is allowed. Additionally, certain thresholds above which authorization is deployed may be utilized. Such an external approval improves solutions for preventing theft via CCDs.

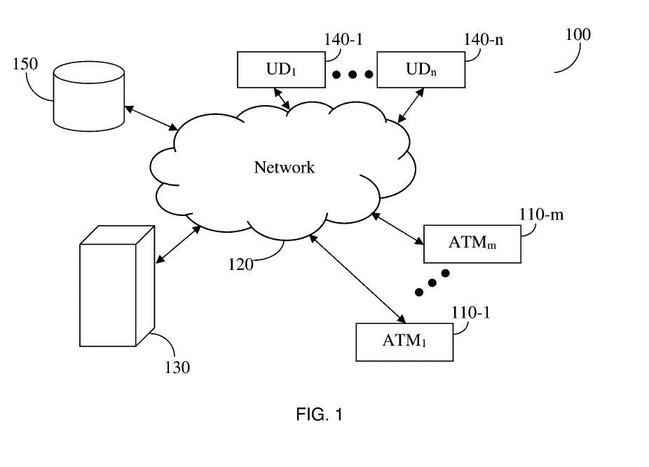

FIG. 1 depicts an exemplary and non-limiting schematic diagram of a system 100 utilized to describe the various disclosed embodiments. Credit clearing devices (CCDs) 110-1 through 110-m (hereinafter referred to collectively as CCDs 110 or individually as a CCD 110, merely for simplicity purposes), where ‘m’ is an integer having a value of ‘1’ or greater, are connected to a network 120. The CCD 110 may be, but is not limited to, an automatic teller machine (ATM), a point of sale (POS) clearing device, and so on. The network 120 may be, but is not limited to, a local area network (LAN), a wide area network (WAN), a metro area network (MAN), the world wide web (WWW), the Internet, a wired network, a wireless network, a cellular network, and the like, as well as any combination thereof.

The CCDs 110 are connected to the network 120 and provide a user interface (UI, not shown) that allows, responsive to entry of a credit, debit, or virtual card (herein referred to as a payment card) and entry of an identification code, access to data and distribution of cash depending on actions taken by a user interfacing with the UI of the CCD 110. According to another embodiment, the payment card may further be used to pay for a certain good or service responsive to entry of the card to the CCD 110. The payment card may include one or more identifiers related to the user such as, but not limited to, a picture of the user, an identification code encoded therein, and so on. The one or more identifiers may enable the user to be identified as an authorized user of the card by the CCD 110.

A server 130 is also connected to the network 120. The server 130 typically comprises an interface to the network 120, a processing system (not shown), and a memory (not shown). The processing system is coupled to the memory and to the network interface. The memory is configured to contain instructions that can be executed by the processing system, thereby providing the benefits of methods implemented by the execution of such instructions by the processing system. In particular, the server 130 is configured to execute the embodiments disclosed herein.

A plurality of user devices (UDs) 140-1 through 140-n (collectively referred to hereinafter as user devices 140 or individually as a user device 140, merely for simplicity purposes) are further connected to the network 120, where ‘n’ is an integer having a value of ‘1’ or greater. The user device 140 may be, but is not limited to, a smart phone, a mobile phone, a laptop, a tablet computer, a wearable computing device, a personal computer (PC), and the like. The server 130 is configured to send the received content to and from the user devices 140. The system 100 may further include a database 150, communicatively connected to the network 120, for storing information related to certain cards and their respective cash withdrawal limitations.

The server 130 is configured to receive notifications of an attempt to perform a financial transaction from a CCD 110. As further described hereinabove, such a financial transaction may be, but is not limited to, a cash withdrawal, a payment attempt, and so on. A notification may include an identification respective of the card used and the withdrawal amount or payment amount requested by the user of the user device 140. The notifications are received through the network 120.

The server 130 is configured to determine whether the financial transaction requires an external authorization from such as, but not limited to, one or more of the UDs 140. The determination may be further based on information stored in the database 150. The information may include one or more preconfigured conditions for approval such as, but not limited to, the type of approval required, the type of the approving device, maximum amounts for a financial transaction, cash in a linked bank account, and so on. In one embodiment, one or more of the conditions are preconfigured by a user device 140.

Upon determination that the financial transaction requires an external authorization, the server 130 sends a request to one or more of the user devices 140 respective of the type of authorization that is required. In an embodiment, one or more preconfigured conditions corresponding to the required authorization type may be received. Upon receiving an authorization that meets the preconfigured conditions, the server 130 sends an authorization notification to the CCD 110. Typically, there is a time limit for a user device 140 to respond to such a request and failure to respond timely may result in denial of authorization. The time response may be a preconfigured time period, e.g., 60 seconds. Respective of the authorization notification, the financial transaction is enabled by the CCD 110. Information regarding the financial transaction may be stored in the database 150 for further use. One of ordinary skill in the art would readily appreciate that in one embodiment the server 130 can be further configured so that two or more responses of authorization may be required to generate an authorization notification to the CCD 110-1.

In a further embodiment, the server 130 may communicate with an authentication server of a financial institute that authenticates/authorizes financial transactions using the conventional protocol implemented by the financial institute and, thus, the server 130 provides another layer of security over such conventional protocol. In an embodiment, the functionality of the server 130, and specifically the various embodiments disclosed herein for authorizing financial transactions, can be implemented or otherwise integrated in such authentication servers.

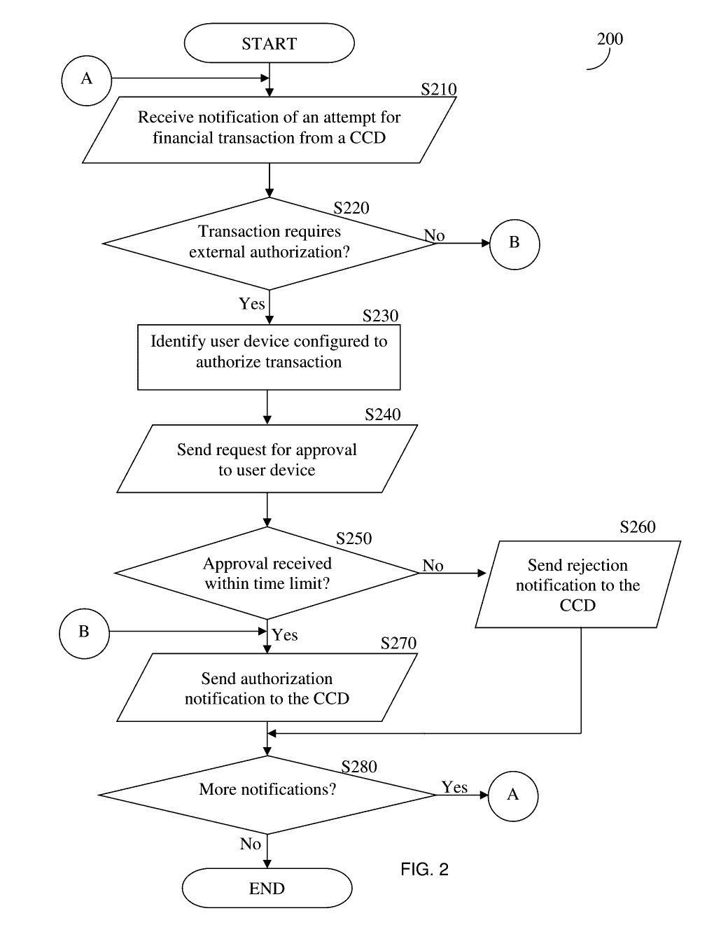

FIG. 2 depicts an exemplary and non-limiting flowchart 200 of a method for authorizing financial transactions from a CCD 110 according to one embodiment. In S210, a notification respective of a card used for a financial transaction attempt from a CCD (e.g., the CCD 110) is received. The notification may include, but is not limited to, one or more of: the amount of cash requested, the amount of payment, the type of card used, the card number, a list of goods/services to be purchased, bank account information, and so on. According to one embodiment, the notification may further include one or more environmental variables related to the environment in which the attempt for the financial transaction occurs. The environmental variables may be, for example, the location of the CCD, businesses in the area of the CCD, the time of day of the attempt for the financial transaction, the location of the attempt for the financial transaction, and so on. According to another embodiment, the notification may further include one or more personal variables related to the user attempting to perform a financial transaction from the CCD. Such variables may be collected by one or more sensors included in the CCD. The personal variables may be, for example, the language selected in the financial transaction attempt, a picture of the person attempting to perform the financial transaction, the amount of time required for the financial transaction attempt, and so on.

In S220, it is checked whether the financial transaction attempt requires an external authorization, i.e., an authorization by one or more user devices (e.g., one or more of the UDs 140) and if so, execution continues with S230; otherwise, execution continues with S270. The check may include a search through a database for preconfigured data indicative of whether the financial transaction requires an external authorization. According to another embodiment, the check may be made based on an analysis of at least a portion of the notification and its associated data. For example, upon identification that the attempt to use the card above a certain cash threshold, it is determined that an external approval is required.

In S230, one or more user devices configured to authorize the financial transaction are identified. In an embodiment, such identification may be based on an analysis of data stored in a database accessible over the web and at least a portion of the information contained in the received notification. For example, the database may store a mapping between a credit card number and a user device that provides the authorization. Such a user device may be identified by a phone number, an instant messaging ID, an email address, a MAC address of the device, a combination thereof, and so on. In an embodiment, the database may include more than two user devices to authorize a transaction with a set of preferences which devices should be a primary authorizer and a secondary authorizer and a time of the day that each device is available.

In S240, a request for authorization is sent to one or more of the identified user devices. According to one embodiment, the request may be sent simultaneously to a plurality of user devices; according to another embodiment, a subsequent request is sent sequentially upon determination that one user device has not responded to a previous request. According to yet another embodiment, the authorization may be preconfigured by the one or more user devices. The preconfigured authorization may be time-limited or capped at a predefined amount of money to be withdrawn and/or paid.

In S250, it is checked whether the required authorization was received and, if so, execution continues with S270; otherwise, execution continues with S260. According to one embodiment, this operation is time limited. In such an embodiment, failure to respond within the time limit may result in a determination that the required authorization was not received.

In an embodiment, the user device authorizing the transaction and the server 130 implements a communication channel to send requests for authorization and received authorization messages from the user devices. The communication channel may be implemented using a short text message (SMS), a dialing tone, an email communion protocol, and/or dedicated software installed on the user device. The dedicated software may be an application, such as a mobile application, a plug-in, an add-on, and the like.

In S260, a rejection notification is sent to the CCD. In one embodiment, a notification of the rejections is also sent to the user device.

In S270, an authorization notification is sent to the CCD. In one embodiment, a notification of the approval is also sent to the user device. In S280, it is checked whether additional notifications have been or are to be received and, if so, execution continues with S210; otherwise, execution terminates.

The steps of flowchart 200 may be implemented by the server 130, the CDD 110 or any computing device communicatively connected between the CCD 110 and the user devices 140. Any type of computing device configured to perform the embodiments disclosed herein includes a processing system. The processing system is configured to authorize a financial transaction by means of a user device located outside of the financial institute, thereby providing another layer of security. The various aspects for authorizing financial transactions are discussed in greater detail herein below with respect to FIG. 2.

The processing system may comprise or be a component of a larger processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

Following is a non-limiting example for the operation of the steps of flowchart 200. A child uses a card for a cash withdrawal attempt from a CCD. A notification respective of the cash withdrawal attempt is sent from the CCD. It is determined that an authorization from at least one the child's parents is required. Respective thereto, and based on the identified user devices of the child's parents, a request is sent to the parents' user devices for a cash withdrawal authorization. The user devices may be equipped with a communication channel to communicate with the server 130, such as, but not limited to, a mobile app in the case of a mobile device, a pop-up utility in the case of a computer, and any other appropriate form of notification that may provide the user of a user device an opportunity to respond with an authorization or rejection of such a cash withdrawal. The utility may further provide details about the requested transaction such as the amount requested, the location of where the transaction is attempted, the time of day at which the transaction was attempted, and so on. Upon receiving an authorization from at least one of the parents' user devices, an authorization notification is sent to the CCD.

The various embodiments may be implemented as hardware, firmware, software, or any combination thereof. Moreover, the software is preferably implemented as an application program tangibly embodied on a program storage unit or tangible computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. All or some of the servers maybe combined into one or more integrated servers. Furthermore, a non-transitory computer readable medium is any computer readable medium except for a transitory propagating signal. The display segments and mini-display segments may be shown on a display area that can be a browser or another other appropriate graphical user interface of an internet mobile application, either generic or tailored for the purposes described in detail hereinabove.

All examples and conditional language recited herein are intended for pedagogical purposes to aid the reader in understanding the principles and the concepts contributed by the inventor to furthering the art, and are to be construed as being without limitation to such specifically recited examples and conditions. Moreover, all statements herein reciting principles, aspects, and embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A computerized method for approval of an electronic payment by a credit clearing device (CCD) comprising:
receiving a first notification respective of a payment card used to attempt a financial transaction from the CCD, the first notification containing information respective of the payment card and the attempted financial transaction;
determining whether the financial transaction requires an external authorization based on at least an analysis of at least a portion of the information contained in the first notification;
upon determination that an external authorization is required, identifying at least one pre-selected user device to authorize the attempted financial transaction;
sending a second notification to the at least one user device; and
sending a third notification to the CCD respective of a response from the at least one user device, wherein the response is any one of: an approval of the attempted financial transaction, and a denial of the attempted financial transaction.

2. The computerized method of claim 1, wherein the CCD is at least one of:
an automatic teller machine (ATM), and a point of sale clearing device.

3. The computerized method of claim 1, wherein the financial transaction is at least one of: a cash withdrawal, and a payment attempt.

4. The computerized method of claim 1, wherein the payment card is at least one of: a credit card, a debit card, and a virtual card.

5. The computerized method of claim 4, wherein the payment card comprises one or more identifiers related to at least one user of the payment card.

6. The computerized method of claim 5, wherein the identifiers are at least one of: a picture of a user, and an identification code encoded in a picture of a user.

7. The computerized method of claim 1, wherein the user device is at least one of: a smart phone, a mobile phone, a laptop, a tablet computer, a wearable computing device, and a personal computer (PC).

8. The computerized method of claim 1, wherein determining whether the financial transaction requires an external authorization is further based on data accessible via a database.

9. The computerized method of claim 8, wherein the information is at least one of: a type of approval required, a type of the approving device, a maximum amount for a financial transaction, and an amount of cash in a linked bank account.

10. The computerized method of claim 1, wherein the first notification further comprises at least one of: an amount of cash requested, an amount of payment, a type of the payment card used, the payment card number, bank account information, one or more environmental variables related to an environment in which the attempt for a financial transaction occurs, one or more personal variables related to a user of the payment card, and a combination thereof.

11. The computerized method of claim 10, wherein the environmental variables are at least one of: a location of the CCD, one or more businesses in the area of the CCD, a time of day of the attempt for a financial transaction, and a location of the attempt for the financial transaction.

12. The computerized method of claim 1, wherein the second notification and the response are transported over a communication channel established with the user device.

13. A non-transitory computer readable medium having stored thereon instructions for causing one or more processing units to execute the method according to claim 1.

14. A system for approval of an electronic payment by a credit clearing device (CCD), comprising:
a processing system; and
a memory, the memory containing instructions that, when executed by the processing unit, configure the system to:
receive a first notification respective of a payment card used to attempt a financial transaction from the CCD, the first notification containing information respective of the payment card and the attempted financial transaction;
determine whether the financial transaction requires an external authorization based on at least an analysis of at least a portion of the information contained in the first notification;
upon determination that an external authorization is required, identify at least one pre-selected user device to authorize the attempted financial transaction;
send a second notification to the at least one user device; and
send a third notification to the CCD respective of a response from the at least one user device, wherein the response is any one of: an approval of the attempted financial transaction, and a denial of the attempted financial transaction.

15. The system of claim 14, wherein the CCD is at least one of: an automatic teller machine (ATM), and a point of sale clearing device.

16. The system of claim 14, wherein the financial transaction is at least one of: a cash withdrawal, and a payment attempt.

17. The system of claim 14, wherein the payment card is at least one of: a credit card, a debit card, and a virtual card.

18. The system of claim 14, wherein the payment card comprises one or more identifiers related to at least one user of the payment card.

19. The system of claim 14, wherein the identifiers are at least one of: a picture of a user, and an identification code encoded in a picture of a user.

20. The system of claim 14, wherein the user device is at least one of: a smart phone, a mobile phone, a laptop, a tablet computer, a wearable computing device, and a personal computer (PC).

21. The system of claim 14, wherein determining whether the financial transaction requires an external authorization is further based on data accessible via a database.

22. The system of claim 14, wherein the information is at least one of: a type of approval required, a type of the approving device, a maximum amount for a financial transaction, and an amount of cash in a linked bank account.

23. The system of claim 14, wherein the first notification further comprises at least one of: an amount of cash requested, an amount of payment, a type of the payment card used, the payment card number, bank account information, one or more environmental variables related to an environment in which the attempt for a financial transaction occurs, one or more personal variables related to a user of the payment card, and a combination thereof.

24. The system of claim 23, wherein the environmental variables are at least one of: a location of the CCD, one or more businesses in the area of the CCD, a time of day of the attempt for a financial transaction, and a location of the attempt for the financial transaction.
